(19) United States
(12) Patent Application Publication
(10) Pub. No.: US 2007/0023487 A1
(43) Pub. Date: Feb. 1, 2007

(54) Wire bonding method and device of performing the same

(75) Inventors: Jun-young Ko, Cheonan-si (KR); Ho-geon Song, Cheonan-si (KR); Jae-yun Lim, Cheonan-si (KR); Dae-sang Chun, Asan-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/447,118

(22) Filed: Jun. 6, 2006

(30) Foreign Application Priority Data
Jul. 29, 2005 (KR) 10-2005-0069662

(51) Int. Cl. B23K 31/00; B23K 31/02

(52) U.S. Cl. 228/180.5; 228/4.5

(57) ABSTRACT

A wire bonding method may involve forming a bonding ball on a leading end of a wire projected from a capillary. The bonding ball may be transformed to increase an area of the mounting surface of the bonding ball. The transformed bonding ball may be bonded to the bonding pad.

### PRIORITY STATEMENT

This application claims the benefit of Korean Patent Application No. 10-2005-0069662, filed on Jul. 29, 2005, in the Korean Intellectual Property Office, the disclosure of which is incorporated herein in its entirety by reference.

### BACKGROUND

1. Field of the Invention

Example embodiments of the present invention relate to a wire bonding method and a device of performing the same, and more particularly, to a wire bonding method that may reduce damage of a bonding pad.

2. Description of the Related Art

Wire bonding may be a way to make an electrical connection between a bonding pad of a semiconductor chip and a mounting member, such as a lead frame or a printed circuit board (PCB), for example. By way of example only, wire bonding may be implemented by a wire that may be made of gold (Au). Also, wire bonding may be performed using a combination of heat, pressure and ultrasonic energy. For example, wire bonding may be implemented via an ultrasonic-thermocompression technique using ultrasonic vibration.

A bonding ball may be formed on a leading end of a wire extended through a capillary. The capillary may move to position the bonding ball on a bonding pad. In the ultrasonic-thermocompression technique, the bonding ball of the wire may be attached to the boding pad of the semiconductor chip by applying force, ultra sonic vibration (or power) and heat to the capillary. The capillary may move above an electrode of the mounting member, and the ultrasonic-thermocompression technique may be performed to connect together the wire and the mounting member. The wire may be cut by applying a tensile force to the capillary.

Various attempts may have been implemented to reduce a parasitic capacitance and to improve processing speed of a semiconductor chip. According to one attempt, an interval between wirings may be insulated in a semiconductor chip, and an interlayer insulating layer that supports the bonding pad may be fabricated from a dielectric material (other than conventional silicon oxide (SiO₂). However, alternative dielectric materials may be mechanically weaker than SiO₂ of a conventional interlayer insulating layer. Thus, the interlayer insulating layer (fabricated from a dielectric material other than SiO₂) may collapse when the bonding pad and the bonding ball are attached to each other. Consequently, a surface of the semiconductor chip may be damaged. For example, it may be difficult to maintain a form of the bonding pad, and also crack damage may occur in the bonding pad.

Instead of gold (Au), the wire used in wire bonding may be fabricated from copper (Cu). However, copper is harder than gold, and more force may be needed for copper wire bonding than gold wire bonding. Consequently, damage to the surface of the semiconductor chip may be more likely.

### SUMMARY

According to an example, non-limiting embodiment, a wire bonding method of connecting a bonding pad of a semiconductor chip to a mounting member using a wire may involve forming a bonding ball on a leading end of the wire projected from a capillary. The bonding ball may be transformed to increase the area of a mounting surface of the bonding ball. The transformed bonding ball may be bonded to the bonding pad.

According to another example, non-limiting embodiment, a wire bonding method of connecting a bonding pad of a semiconductor chip to a mounting member using a wire may involve forming a bonding ball on a leading end of a wire projected from a capillary. The bonding ball may be transformed to increase an area of a mounting surface of the bonding ball. The transformed bonding ball and the bonding pad may be ultrasonic-thermocompressed. The capillary may be moved to an electrode of the mounting member. The wire of the capillary and the electrode of the mounting member may be ultrasonic-thermocompressed. The wire may be cut.

According to another example, non-limiting embodiment, a wire bonding device for connecting a bonding pad of a semiconductor chip to a mounting member using a wire may include a capillary to support a wire. A cut clamp may be disposed adjacent to the capillary to cut the wire by applying an electrical potential and a tensile force to the wire in the capillary. A torch rod may be provided to form a bonding ball by providing a discharge voltage to a wire projected from the capillary. A transducer may be provided to support the capillary to provide an ultrasonic vibration to the capillary. A supporter may be provided to support the mounting member and the semiconductor chip. A plate member may be provided to transform a bonding ball of the wire.

According to another example, non-limiting embodiment, a wire bonding method may involve forming a bonding ball on an end of a wire. The bonding ball may be mechanically pressed to change the shape of the bonding ball. After mechanically pressing the bonding ball, the bonding ball may be bonded to a bonding pad.

### BRIEF DESCRIPTION OF THE DRAWINGS

Example, non-limiting embodiments of the present invention will be described with reference to the attached drawings.

FIG. 1 is a schematic view of a wire bonding device according to an example embodiment of the present invention.

FIG. 2 is a plan view of a supporter supporting a semiconductor chip in a wire bonding device.

FIG. 3 is a schematic view of a wire bonding device including a plate member moving x, y, and z directions according to another example embodiment of the present invention.

FIG. 4 is a sectional view of a plate member having an uneven part according to another example embodiment of the present invention.

FIGS. 5A through 5G are sectional views of a wire bonding method according to an example embodiment of the present invention.

The drawings are provided for illustrative purposes only and are not drawn to scale. The spatial relationships and relative sizing of the elements illustrated in the various embodiments may be reduced, expanded and/or rearranged to improve the clarity of the figure with respect to the corresponding description. The figures, therefore, should not be interpreted as accurately reflecting the relative sizing or positioning of the corresponding structural elements that could be encompassed by an actual device manufactured according to example embodiments of the invention. Like reference numerals in the drawings denote like elements, and thus their description may be omitted.

### DETAILED DESCRIPTION OF EXAMPLE, NON-LIMITING EMBODIMENTS

Example, non-limiting embodiment of the present invention will be described with reference to the accompanying drawings. The invention may, however, be embodied in many different forms and should not be construed as being limited to the embodiments set forth herein; rather, the disclosed embodiments are provided so that this disclosure will be thorough and complete, and will fully convey the concept of the invention to those skilled in the art.

Well-known structures and processes are not described or illustrated in detail to avoid obscuring the present invention.

An element is considered as being mounted (or provided) “on” another element when mounted or provided) either directly on the referenced element or mounted (or provided) on other elements overlaying the referenced element. Throughout this disclosure, spatial terms such as “upper,” “lower,” “above” and “below” (for example) are used for convenience in describing various elements or portions or regions of the elements as shown in the figures. These terms do not, however, require that the structure be maintained in any particular orientation.

According to an example, non-limiting embodiment of the present invention, the shape of a bonding ball at a leading end of a wire may be transformed. By way of example only, the bonding ball may be transformed to have a disk shaped mounting surface. The transformed bonding ball may be attached to the bonding pad. As compared to the original bonding ball, the transformed bonding ball may have a mounting surface with an increased area. The mounting surface of the bonding ball may be the surface that makes initial contact with the bonding pad during the wire bonding process. Thus, a wire bonding between the transformed bonding ball and the bonding pad may be achieved with reduced force. Consequently, an interlayer insulating layer may be fabricated from a dielectric material (other than SiO₂) having low mechanical strength, the chances of damaging the bonding pad and collapsing an interlayer insulting layer may be reduced, and/or a copper wire may be used for wire bonding without necessarily increasing the chances of damaging the surface of the semiconductor chip.

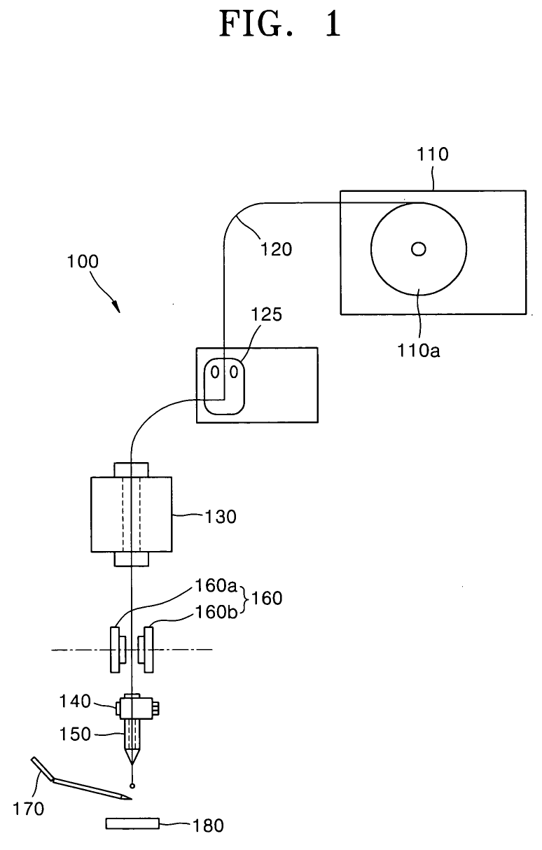

FIG. 1 is a schematic view of a wire bonding device according to an example embodiment of the present invention. Referring to FIG. 1, the wire bonding device 100 may include a spool unit 110, a wire guide 125, an air clamp 130, a capillary 150, a cut clamp 160, a torch rod 170, and a plate member 180.

A spool 100a, which may be rolled with a wire 120, may be mounted on the spool unit 110. The wire 120 may be fabricated from copper and/or gold, for example. In alternative embodiments, the wire 120 may be fabricated from some other conductive material. The wire 120 may pass through the wire guide 125 and the air clamp 130, and may be inserted into a hole (now shown) of the capillary 150. The air clamp 130 may serve to pull the wire 120. The capillary 150 may be supported by a transducer 140 for movement in x, y, and z directions.

The transducer 140 may be installed at both sides of the capillary 150 to support the capillary 150. The transducer 140 may drive a front end of the capillary 150 to a contact object (e.g., a bonding pad and/or an electrode of a mounting member), and may provide ultrasonic vibration to the capillary 150.

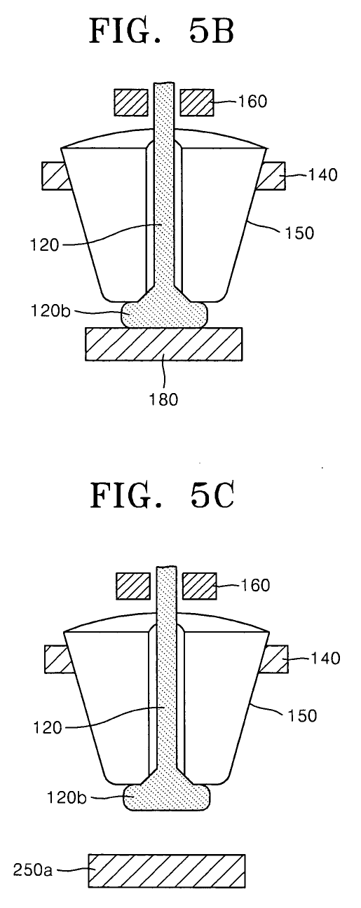

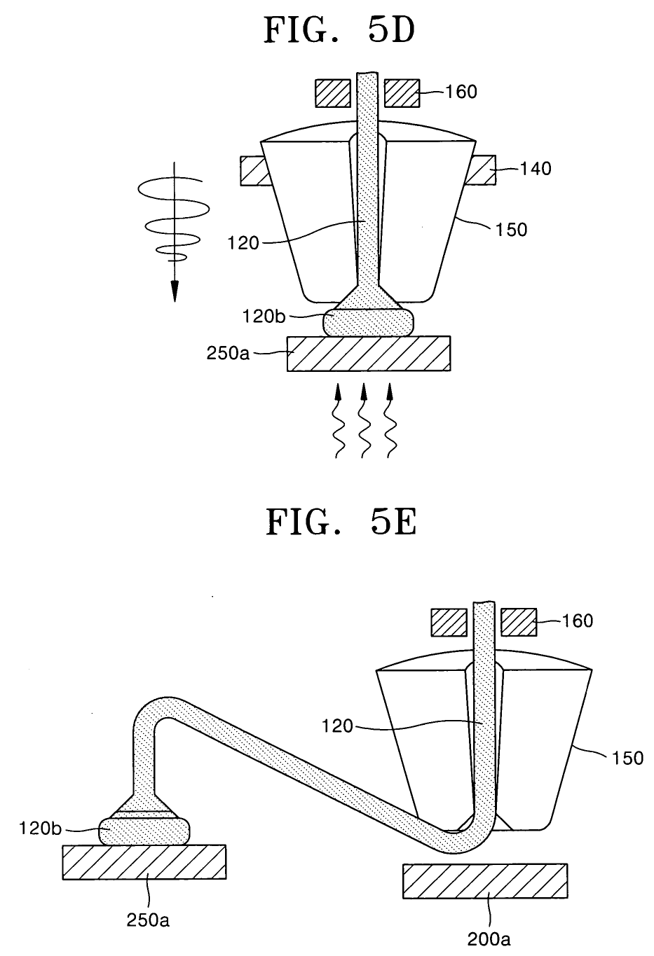

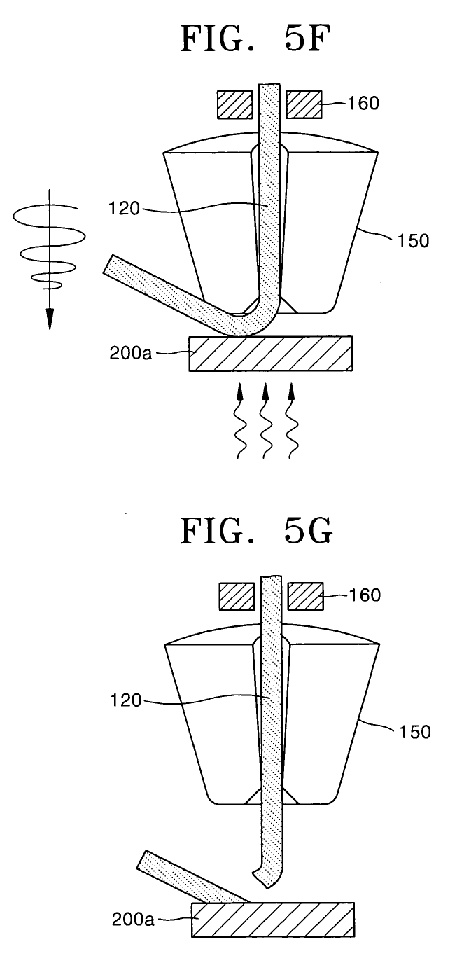

The cut clamp 160 may be disposed between the capillary 150 and the air clamp 130. The torch rod 170 may be disposed in the vicinity of the front end of the capillary 150. The cut clamp 160 may include a pair of electrodes 160a and 160b installed at sides of the wire 120. The electrodes 160a and 160b may apply an electric potential to the wire 120. The cut clamp 160 may cut the wire 120 by applying a tensile force to the capillary 150 that includes the wire 120. The torch rod 170 may be provided with an electrical potential, for example, a discharge voltage. The torch rod 170 may play a role in forming the bonding ball 120a in FIG. 5A at the leading end of the wire 120 extending from the capillary 150.

By way of example only, the bonding ball (120a in FIG. 5A) may be formed when the wire 120, which may be provided with an electrical potential from the cut clamp 160, may contact the torch rod 170, to thereby generate a spark discharge. This may melt the leading end of the wire, which may form into a ball because of the surface tension of the molten metal. That is, the bonding ball 120a may be formed when the leading end of the wire 120 is melted (by the spark discharge) and cooled.

The plate member 180 may serve to transform the bonding ball 120a before the bonding ball 120a may be attached to the bonding pad. By way of example only, the plate member 180 may be fabricated from an insulating material. The platen member 180 may transform the shape of the bonding ball 120 without being bonded to the bonding ball 120a.

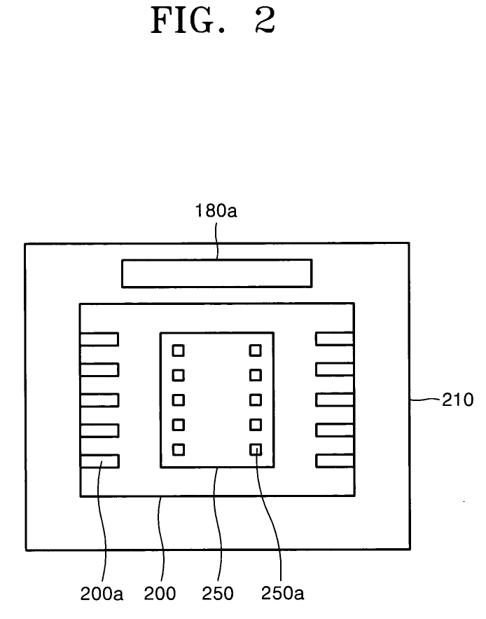

Referring to FIG. 2, a plate member 180a may be disposed on a supporter 210 where a mounting member 200 may be seated. Here, the mounting member 200 may be a lead frame, for example. The lead frame 200 may include inner lead 200a. The lead frame 200 may support a semiconductor chip 250. The semiconductor chip 250 may include a bonding pad 250a.

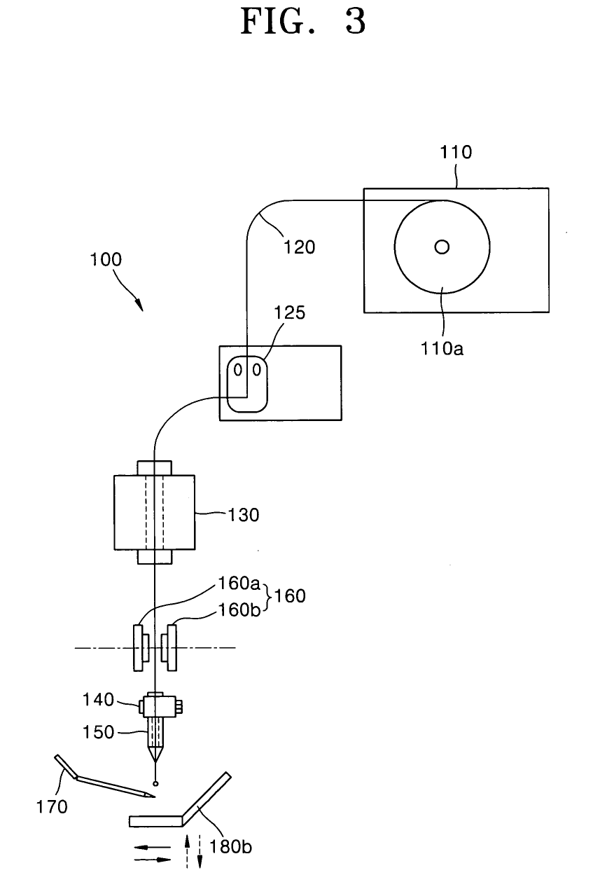

In an alternative embodiment, and referring to FIG. 3, a plate member 180b may be a separate and distinct element from the supporter 210. Here, the plate member 180b may move in x, y, and z directions like the torch rod 170 and the capillary 150.

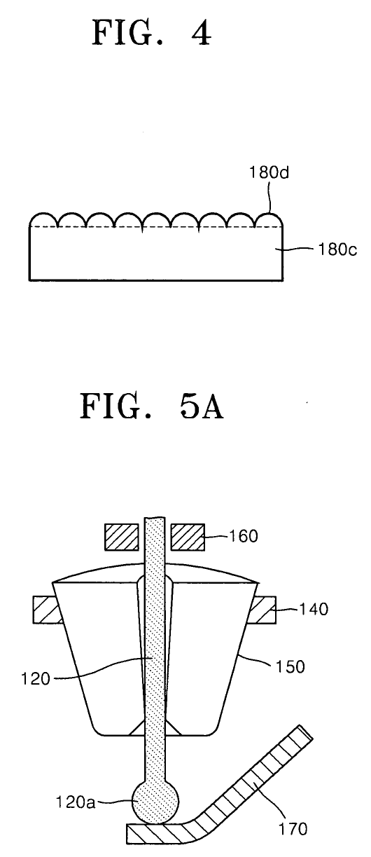

In an alternative embodiment, and referring to FIG. 4, the plate member 180c may include an uneven part 180d. By way of example only, the uneven part 180d may have a thickness of 1-20 μm and may be formed on the surface of the plate member 180c.

A wire bonding method according to an example, non-limiting embodiment will be described with reference to FIGS. 5A-5G.

Referring to FIG. 5A, the torch rod 170 may contact with the leading end of the wire 120 projected from a capillary 150 to form a bonding ball 120a.

Referring to FIG. 5B, the bonding ball 120a may be disposed on the plate member 180. The bonding ball 120a (which may have a spherical shape) may be transformed by pressing the capillary 150 toward the plate member 180. The capillary 150 together with the transformed bonding ball 120b may be moved away from the plate member 180. In this example embodiment, the transformed bonding ball 120b may have a disk shape. In alternative embodiment, the transformed bonding ball may have numerous and varied shapes. The transformed shape of the bonding ball may be influenced by the shape of the plate member 180 and the pressure exerted on the bonding ball, for example. As compared to the originally formed bonding ball 120a (which may have a spherical shape as shown in FIG. 5A), the transformed bonding ball 120b may have a mounting surface with an increased area for attachment to a bonding pad.

Referring to FIG. 2, when the plate member 180a is disposed on the supporter 210, the bonding ball 120a may be transformed by applying pressure after the capillary 150 is moved to a position located over the plate member 180a.

Referring to FIG. 3, the bonding ball 120a may be transformed by applying pressure after the plate member 180b is moved to a position below the capillary 150. The bonding ball 120a may be transformed by moving the capillary 150 up and down.

Referring to FIG. 4, when the surface of the plate member 180c has an uneven part 180d, the mounting surface of the bonding ball 120a may have an overall disk shape, but may also have raised features and/or recessed features.

Referring to FIG. 5C, the capillary 150 may move to position the transformed bonding ball 120b above a bonding pad 250a of a semiconductor chip 250 (see FIG. 2). Here, the mounting surface of the transformed bonding ball 120b may confront the upward facing surface of the bonding pad 250a.

Referring to FIG. 5D, the transformed bonding ball 120b may be attached to the bonding pad 250a by applying pressure to the capillary 150. Because the bonding ball 120b has been transformed to increase a bonding area, a reduced force may be applied to bond the transformed bonding ball 120b to the bonding pad 250a. A bonding efficiency may be improved in a bonding process by inducing metal diffusion between the transformed bonding ball 120b and the bonding pad 250a. An ultrasonic-thermocompressing technique may be performed to remove an oxide layer (not shown) that may exist on the surface of the bonding pad 250a by (for example) applying ultrasonic vibration of 60,000-100,000 Hz, maintaining a semiconductor chip 250 at the temperature range of 120-250° C., and applying power of 80-150 mA and force of 15-30 g. The temperature may be controlled by a heater (not shown) mounted on the bottom of the supporter 210 and/or within the supporter 210.

Referring to FIG. 5E, the capillary 150 may move to a position above an inner lead 200a. During this movement, the wire 120 may pass out through the capillary 150.

Referring to FIG. 5F, an ultrasonic-thermocompression technique may be performed to connect together the wire 120 and the inner lead 200a by applying an ultrasonic vibration using a transducer 140 after the wire 120 at the front end of the capillary 150 is pressed. The wire 120 may be in a loop shape and may be attached to the inner lead 200a.

Referring to FIG. 5G, the cut clamp 160 may cut the wire 120 by lifting the capillary 150. The wire bonding process may be performed again by returning to the process of forming the bonding ball in FIG. 5A.

As described above, the bonding ball formed at the leading end of a wire may be transformed before the wire is attached to a bonding pad. The transformed bonding ball may present an increased surface area to be attached to the bonding pad. After that, the transformed bonding ball may be bonded to the bonding pad of the semiconductor chip. In this way, example embodiments of the present invention may (for example) improve a bonding efficiency and/or reduce an applying force during the wire bonding process.

Accordingly, even if a dielectric material (other than SiO₂) may be used for an interlayer insulating layer, and/or if copper may be used for a wire, the chances of damaging the bonding pad and/or collapsing the interlayer insulating layer may be reduced because the force applied on the bonding pad during the wire bonding process may be reduced.

The present invention has been described with reference to example, non-limiting embodiments. It will be understood by those of ordinary skill in the art that various changes in form and details may be suitably implemented without departing from the spirit and scope of the present invention as defined by the following claims.

What is claimed is:

1. A wire bonding method of connecting a bonding pad of a semiconductor chip to a mounting member using a wire, the method comprising:
forming a bonding ball on a leading end of the wire projected from a capillary;
transforming the bonding ball to increase the area of a mounting surface of the bonding ball; and
bonding the transformed bonding ball to the bonding pad.

2. The method of claim 1, wherein forming the bonding ball comprises touching a torch rod to the wire while an electric potential is applied to the wire.

3. The method of claim 1, wherein transforming the bonding ball comprises:
moving the capillary to an insulating plate member; and
pressing the capillary against the insulating plate member.

4. The method of claim 1, wherein transforming the bonding ball comprises:
moving an insulating plate member to the capillary; and
pressing the capillary against the insulating plate member.

5. The method of claim 1, wherein bonding the transformed bonding ball comprises:
maintaining a semiconductor chip in a temperature range of 120-250° C.; and
applying power of 80-150 mA and force of 15-30 g.

6. The method of claim 5, wherein bonding the transformed bonding ball comprises applying an ultrasonic vibration of 60,000-100,000 Hz.

7. The method of claim 1, further comprising:
moving the capillary to an electrode of the mounting member;
ultrasonic-thermocompressing the wire of the capillary and the electrode of the mounting member; and
cutting the wire.

8. A wire bonding method of connecting a bonding pad of a semiconductor chip to a mounting member using a wire, the method comprising:
forming a bonding ball on a leading end of the wire projected from a capillary;
transforming the bonding ball to increase an area of a mounting surface of the bonding ball;
ultrasonic-thermocompressing the transformed bonding ball and the bonding pad;
moving the capillary to an electrode of the mounting member;
ultrasonic-thermocompressing the wire of the capillary and the electrode of the mounting member; and
cutting the wire.

9. The method of claim 8, wherein forming the bonding ball comprises touching a torch rod to the wire while an electric potential is applied to the wire.

10. The method of claim 8, wherein transforming the bonding ball comprises:
moving the capillary to an insulating plate member; and
pressing the capillary against the insulating plate member.

11. The method of claim 8, wherein transforming the bonding ball comprises:
moving an insulating plate member to the capillary; and
pressing the capillary against the insulating plate member.

12. The method of claim 8, wherein ultrasonic-thermocompressing the transformed bonding ball and the bonding pad comprises:
maintaining a semiconductor chip at a temperature range of 120-250° C.;
applying power of 80-150 mA and force of 15-30 g; and
applying ultrasonic vibration of 60,000-100,000 Hz.

13. The method of claim 8, wherein the wire bonding method is repeated after cutting the wire.

14. A wire bonding device for connecting a bonding pad of a semiconductor chip to a mounting member using a wire, the wire bonding device comprising:
a capillary to support the wire;
a cut clamp disposed adjacent to the capillary to cut the wire by applying an electrical potential and a tensile force to the wire in the capillary;
a torch rod to form a bonding ball by providing a discharge voltage to a wire projected from the capillary;
a transducer supporting the capillary to provide an ultrasonic vibration to the capillary;
a supporter to support the mounting member and the semiconductor chip; and
a plate member to transform a bonding ball of the wire.

15. The device of claim 14, wherein the plate member has an insulating property.

16. The device of claim 14, wherein the plate member is disposed on the supporter.

17. The device of claim 14, wherein the plate member is moveable in x, y, and z directions relative to the capillary.

18. The device of claim 14, wherein the plate member has an uneven part on a surface thereof.

19. The device of claim 18, wherein the uneven part has a height of 1-20 μm.

20. A wire bonding method comprising:
forming a bonding ball on an end of a wire;
mechanically pressing the bonding ball to change the shape of the bonding ball; and
after mechanically pressing the bonding ball, bonding the bonding ball to a bonding pad.
